(19) United States
(12) Patent Application Publication
(10) Pub. No.: US 2020/0011709 A1
(43) Pub. Date: Jan. 9, 2020

(54) SENSOR DEVICE FOR CAPTURING THE ROTATIONAL POSITION OF A ROTATING SHAFT WITH ULTRASONICALLY WELDED ENCODER MAGNETS

(71) Applicants: THYSSENKRUPP PRESTA AG, Eschen (LI); thyssenkrupp AG, Essen (DE)

(72) Inventor: Albert RAUCH, Schlins (AT)

(73) Assignees: THYSSENKRUPP PRESTA AG, Eschen (LI); thyssenkrupp AG, Essen (DE)

(21) Appl. No.: 16/482,047

(22) PCT Filed: Jan. 24, 2018
(86) PCT No.: PCT/EP2018/051706

§ 371 Date: Jul. 30, 2019

(30) Foreign Application Priority Data
Jan. 31, 2017 (DE) 10 2017 000 850.7

(51) Int. Cl. G01D 5/244; B62D 6/00

(52) U.S. Cl. CPC G01D 5/24442; B62D 5/0424; B62D 6/00

(57) ABSTRACT

A sensor device may be utilized to detect an angular position of a rotating shaft that is rotatably supported in a housing. The sensor device may include a transducer magnet that is attached to a supporting part that is connected to the rotating shaft. The supporting part may be joined to the transducer magnet by an ultrasonic weld. The ultrasonic weld may be bonded and shape-locking. The supporting part may be configured as a sonotrode during creation of the ultrasonic weld. Further, an exterior of the supporting part, which can be a supporting rod, may comprise cross knurling or longitudinal knurling.

The present invention concerns a sensor device for detecting the angular position of a rotating shaft with the features of the preamble of claim 1, a method for assembling such a sensor device with the features of the preamble of claim 8 and an electromechanical power steering system.

Sensor devices for detecting the angular position of a rotating shaft conventionally comprise ring magnets, which are used as motor magnets, for example, wherein the base body that holds the magnet is attached to an engine shaft with a press fit. If possible, no mechanical stresses should be transferred to the ring magnet, so that it cannot tear off or break away from the base body. The use of ring magnets as motor magnets requires ensuring resistance to twisting and resistance to axial displacement. It requires force-locking or shape-locking connections, because adhesive bonds do not guarantee a permanently secure attachment.

From EP 2 350 573 B1 a sensor device is known for detecting the angular position of a rotating shaft, which has a ring-shaped transducer magnet sitting on a supporting rod, wherein the transducer magnet is implemented as an injection molded component and is molded onto the supporting rod. It is also provided that a positive joint between the supporting rod and the transducer magnet will be made by means of radial depressions and radial elevations. This allows a particularly good joint to be established between the supporting rod and the transducer magnet.

It is the object of the present invention to specify a sensor device for detecting the angular position of a rotating shaft that comprises a twist-resistant connection between the ring magnet and a base body supporting the ring magnet.

This object is achieved by a sensor device for detecting the angular position of a rotating shaft with the features of claim 1 and by a method for assembling such a sensor device with the features of claim 8 as well as an electromechanical power steering system with the features of claims 15 and 16.

Thus, a sensor device is provided for detecting the angular position of a rotating shaft, which is rotatably supported in a housing, with a transducer magnet attached to a supporting part that is joined to the shaft, wherein the supporting part is joined to the magnet by ultrasonic welding. Ultrasonic welding creates a secure joint between the supporting part and the magnet. Preferably, the joint is bonded and shape-locking. It is preferred if the supporting part acts as a sonotrode during the ultrasonic welding.

In one embodiment, the supporting part is a supporting rod. Furthermore, it is conceivable and possible that the supporting part is a sleeve or a rotating shaft. It is preferable if the transducer magnet is of annular form and encloses the supporting rod.

Preferably, the supporting part has knurling on the outside. This knurling can be cross knurling or longitudinal knurling, for example. Furthermore, the knurling can be embodied as straight knurling and/or lateral knurling and/or oblique knurling. This improves the joint between the transducer magnet and the supporting rod.

Furthermore, a method is provided for assembling a sensor device for detecting the angular position of a rotating shaft that is rotationally supported in a housing, with a transducer magnet that can be fastened to a supporting part, which can be joined to the shaft, wherein the method has the following steps:
Partially inserting the supporting part into the magnet with a defined contact pressure,
Introducing a high-frequency mechanical vibration in the ultrasonic range into the carrier part,
Pressing the supporting part into the magnet with a defined contact pressure, which is preferably carried out fully,
Inserting the supporting part into the shaft.

Preferably, the high frequency vibration is in a range of 20 to 40 kHz, especially about 35 kHz.

It is further preferred if the magnet has plastic in its composition and is partially heated and plasticized when the high-frequency mechanical vibration is introduced into the carrier part.

In one embodiment, the supporting part is a supporting rod. In this case it is preferable if the transducer magnet is formed in an annular shape and encloses the supporting rod.

Preferably, the supporting part has knurling on the outside, so that the plasticized magnet flows around undercuts of the knurling when the supporting part is fully pressed into the magnet. After cooling there is thus a shape-locking and bonded joint between the magnet and the supporting rod.

The ring magnet may have a central recess, preferably a circular opening or a bore, in which a connecting section of the supporting part is fixed. The internal diameter of the recess can be slightly smaller at least in sections than the outer diameter in the connecting section of the supporting part, which can be embodied as a supporting rod. The width of the ring magnet in the axial direction corresponds to the axial extent of the recess, with which it sits on the supporting rod in the region of its connecting section.

In the connecting section, the supporting part may have thickening, which has a larger external diameter than the internal diameter of the recess. Preferably, the thickening extends axially over a section of the connecting section, in other words the width of the thickening is less than the width of the ring magnet.

Preferably, the width of the thickening, measured in the axial direction, is between 10 and 80% of the width of the ring magnet, especially preferably between 30 and 50%.

The external diameter of the supporting rod in the connecting section is preferably smaller than the internal diameter of the recess outside the thickening. The diameter play is measured in such a way that the supporting rod with the connecting section can be axially inserted into the recess without deformation. In the region of the thickening, the diameter is larger than or equal to the internal diameter of the recess, so that when the connecting section is inserted into the recess, a particularly intimate, especially closer contact of the thickening with the recess takes place, which can be accompanied by a local plastic deformation, than in the region of the connecting section outside the thickening. As a result, an increased energy input occurs locally in the region of the thickening during ultrasonic welding, causing a strong joint there.

Preferably, the connecting section comprises an insertion section in the region of the free end outside the thickening. Due to the fact that the insertion section has a smaller external diameter than the internal diameter of the recess, the connecting section can be easily inserted into the recess, wherein the supporting rod is guided and positioned within the ring magnet without play. The thickening can then be inserted further into the recess while introducing a high-frequency mechanical vibration in the ultrasonic range, resulting in a greater force effect that ensures reliable welding in the region of the thickening.

Looking from the end, a guide section can be connected to the thickening that can have an external diameter as with the previously described insertion section.

The sum of the width of the thickening, of the insertion section and of the guide section—measured in an axial direction—preferably corresponds to at least the width of the ring magnet. The ratio of the width of the thickening to the width of the insertion section is preferably about 0.8:1 to 1.5:1, particularly preferably 1:1. The width of the insertion section to the width of the guide section can be about 1:1.

The external diameter of the thickening can have an oversize relative to the inner diameter of 0.1 to 0.4 mm, preferably 0.1 to 0.2 mm.

The thickening is preferably implemented as knurling. The knurling is a plastic material deformation in which alternate radial impressions and radial protrusions are formed in the outer surface of the connecting section. As a result, the external diameter in the region of the knurling, which is formed by the envelope of the raised areas, is increased to form the thickness.

As a result of the fact that the envelope of the knurling has a larger external diameter, the raised areas of the material are pressed radially against the inner wall of the recess during insertion and are welded to the ring magnet under the influence of the introduced high frequency mechanical vibrations in the ultrasonic range. One advantage of the knurling is that it allows the thickening to be produced in the required width with little effort and flexibly in terms of dimensions.

It is further conceivable and possible that the supporting part will be inserted into a recess in the rotating shaft and joined thereto by ultrasonic welding.

Here, the supporting part also has knurling on the area facing the transducer magnet, so that there is a bonded and shape-fitting joint between the supporting rod and the rotating shaft.

There is also an electromechanical power steering system for a motor vehicle, comprising a previously described sensor device, wherein the shaft is a steering shaft of the power steering or a rotor shaft of an electric motor.

An exemplary embodiment of the present invention is described below based on the drawings. Identical components or components with the same functions bear the same reference characters. In the figures:

FIG. 1: shows a schematic representation of a known electromechanical power steering system;

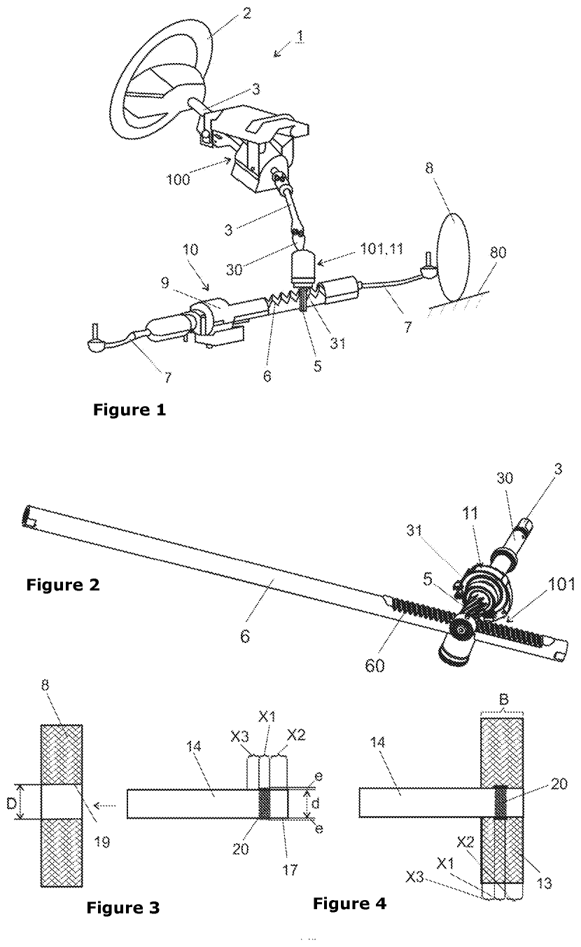

FIG. 2: shows a steering gearbox of a steering system according to FIG. 1

FIG. 3: shows a schematic representation of the assembly of part of a sensor device for detecting the angular position of a rotating shaft in a first step,

FIG. 4: shows a schematic representation of a second step of the assembly,

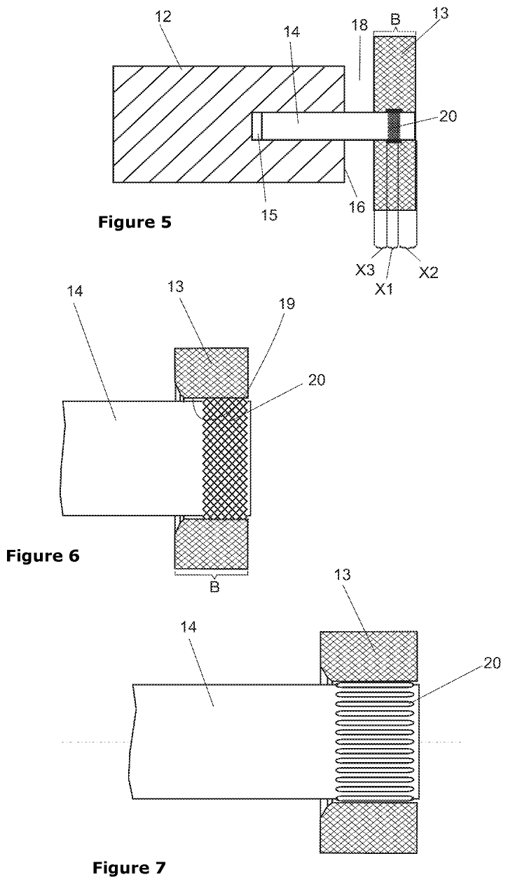

FIG. 5: shows a schematic representation of a third step of the assembly,

FIG. 6: shows a schematic representation of a first embodiment of a rod that is part of the sensor device, and

FIG. 7: shows a schematic representation of a second embodiment of the rod.

In FIG. 1, an electromechanical motor vehicle power steering system 1 is schematically shown with a steering wheel 2, which is rotationally fixedly coupled to a steering shaft 3. By means of the steering wheel 2, the driver applies a suitable torque to the steering wheel 3 as a steering command. The torque is then transferred to a steering pinion 5 via the steering shaft 3. The pinion 5 meshes in a well-known way with a tooth segment 60 of a rack 6. The steering pinion 5, together with the rack 6, forms a steering gearbox, which is shown individually in FIG. 2. The rack 6 is supported in a steering housing so as to be movable along its longitudinal axis. At the free end thereof, the rack 6 is joined to track rods 7 by means of ball joints that are not shown. The track rods 7 themselves are connected in a well-known way via axle stubs to a steered wheel 8 of the motor vehicle. A rotation of the steering wheel 2 causes a longitudinal shift of the rack 6 via the connection of steering shaft 3 and the pinion 5 and thus causes pivoting of the steered wheels 8. The steered wheels 8 experience a reaction via the road 80 that counteracts the steering motion. To pivot the wheels 8 therefore requires a force that requires an appropriate torque on the steering wheel 2. An electric motor 9 with a rotor position sensor (RPS) of a servo unit 10 is provided to assist the driver in this steering motion.

The steering shaft 3 comprises an input shaft 30 connected to the steering wheel 2 and an output shaft 31 connected to the steering pinion 5. The input shaft 30 and the output shaft 31 are rotationally elastically coupled together by a torsion rod that is not shown. A torque sensor unit 11 as depicted in FIG. 2 detects the twisting of the input shaft 30 relative to the output shaft 31 as a measure of the torque manually applied to the steering shaft 3 or the steering wheel 2. This twisting between the input shaft 30 and the output shaft 31 can be determined using a rotation angle sensor. Said rotation angle sensor is also known as the torque sensor. The torque sensor unit 11 comprises a ring magnet (permanent magnet) rotationally fixedly connected to the upper steering shaft 3 and magnetic flux conductors. Depending on the torque measured by the torque sensor unit 11, the servo unit 10 provides steering assistance to the driver. The servo unit 10 can be coupled as an auxiliary force support device 10, 100, 101 to either a steering shaft 3, the steering pinion 5 or the rack 6. The respective auxiliary force support device 10, 100, 101 introduces an auxiliary force moment into the steering shaft 3, the steering pinion 5 and/or into the rack 6, which assists the driver with the steering effort. The three different auxiliary force support devices 10, 100, 101 presented in FIG. 1 show alternative positions for their arrangement. Typically, only a single one of the positions shown is occupied by an auxiliary force support device. The servo unit can be used as a superimposed steering device on the steering column or as an auxiliary force support device on the pinion 5 or the rack 6.

FIGS. 3 through 5 show the assembly of part of a sensor device for detecting the angular position of a rotating shaft 12, preferably an engine shaft. The rotating shaft can also be the input shaft 30 or the output shaft 31. The sensor device comprises a transducer magnet 13 that is rotationally fixedly connected to the shaft 12. The transducer magnet 13 is attached to a supporting rod 14 that is inserted into a recess 15 that is introduced into an end face 16 of the shaft 12. The transducer magnet 13 is a ring magnet that sits on an end 17 of the supporting rod 14 remote from the shaft. The supporting rod 14 thus connects the transducer magnet 13 to the shaft 12, wherein there is an air gap 18 between the transducer magnet 13 and the end face 16 of the shaft 12.

During the assembly of the sensor device, the supporting rod 14 is displaced towards the magnet 13 as far as possible with a predefined pressure until there is contact between an outer surface of the supporting rod 14 and an inner surface of the magnet, for example produced by knurling 20. The ring magnet 13 has a central recess 19, which is designed to be at least partly smaller than the external diameter of the supporting rod 14. After the first application of the magnet 13 to the supporting rod 14, a bonded joint is made between the magnet 13 and the supporting rod 14 with ultrasonic welding, as depicted in FIG. 4. During this assembly step, high-frequency mechanical vibrations in the ultrasonic range are introduced into the supporting rod 14, which is set into resonant vibrations. The supporting rod thus acts as a sonotrode. The frequency range of the resonant vibration is between 20 and 90 kHz, preferably 35 kHz. The vibration direction is oriented perpendicularly to the joint surface with the transducer magnet 13, so that the joint partners rub against each other. The supporting rod 14 is pressed into the magnet 13 with a defined pressure. The interface friction with a defined pressure heats the magnet 13 locally on the contact surface with the supporting rod 14, melts the magnet and thus plastically deforms the magnet. As a result of continuing the pressure, the supporting rod 14 sinks into the recess 19, which is preferably implemented as a bore. Preferably, the transducer magnet 13 has a plastic component in its magnetic composition. The supporting rod 14 is preferably made of metal. Ultrasonic welding joins the supporting rod 14 to the transducer magnet 13 in a bonded and shape-locking manner. Then the supporting rod 14 with the magnet 13 disposed thereon is joined to the shaft 12.

In a preferred embodiment, the end of the supporting rod 14 that can be introduced into the transducer magnet 13 has knurling 20 on the exterior. In contrast to this, the surface of the recess 19 of the magnet 13 is preferably designed to be flat or smooth. As depicted in FIGS. 6 and 7, said knurling can for example be cross knurling (FIG. 6) or longitudinal knurling (FIG. 7). During assembly or ultrasonic welding, the molten mass of the magnet 13 flows around the undercuts of the knurling 20, so that after cooling there is a shape-locking and bonded joint between the magnet 13 and the supporting rod 14.

The transducer magnet 13 measured in an axial direction has a width B, within which it sits on the supporting rod 14. In the region of the far end of the shaft there is an insertion section, which has a width X2, followed by a thickening with the width X1, which is formed as knurling 20 in the example shown. The knurling 20 is followed by a guide section in the direction of shaft 12 that is denoted by the width X3 thereof. The sum of the widths X1, X2 and X3 is essentially equal to the width B of the transducer magnet 13, which corresponds to the width of a connecting section of the supporting rod 14.

The recess 19 of the transducer magnet 13 has an internal diameter D. In the region of the insertion section X2 and the guide section X3, the supporting rod 14 has an external diameter d that is preferably smaller than the internal diameter D. In the region of the knurling 20, raised radial areas of material are formed by the plastic material displacement with a height e as shown in FIG. 3, so that the knurling 20 forms a thickening with an enlarged diameter (d+2×e), wherein:

d+2×e≥D.

With the insertion section X2, the supporting rod 14 can be easily and accurately inserted into the recess 19, and the ultrasonic welding is carried out in the region of the knurling 20 as described above.

The rotating shaft 12 can be a rotor shaft of the electric motor 9, for example. The electric motor has a rod in a housing and fixed to the housing as well as a rotationally supported rotor shaft, the angular position of which is detected by means of a sensor device (rotor position sensor). The sensor device includes the transducer magnet 13, which is rotationally fixedly joined to the rotor shaft 12, as well as a sensor that is disposed fixed to the housing and that is capable of detecting magnetic field changes that arise when the rotor shaft and the transducer magnet rotate. The corresponding sensor signals of the sensor are evaluated in a regulating unit or a control unit and can be used to adjust the electric motor. For example, the sensor is an AMR sensor (anisotropic magnetoresistive effect) or a Hall sensor.

However, the rotating shaft 12 can also be a steering shaft, wherein the transducer magnet 13 is part of the torque sensor unit 11. In this case, it is provided that the transducer magnet is a ring magnet that is also joined to the steering shaft via a supporting element, for example in the form of a sleeve, using ultrasonic welding.

1.-16. (canceled)

17. A sensor device for detecting an angular position of a rotating shaft that is rotatably supported in a housing, the sensor device comprising a transducer magnet that is attached to a supporting part that is connected to the rotating shaft, wherein the supporting part is joined to the transducer magnet via an ultrasonic weld.

18. The sensor device of claim 17 wherein the ultrasonic weld is bonded and shape-locking.

19. The sensor device of claim 17 wherein the supporting part is configured as a sonotrode during creation of the ultrasonic weld.

20. The sensor device of claim 17 wherein the supporting part is a supporting rod.

21. The sensor device of claim 20 wherein the transducer magnet is ring-shaped and encloses the supporting rod.

22. The sensor device of claim 17 wherein an exterior of the supporting part comprises knurling.

23. The sensor device of claim 22 wherein the knurling is cross knurling.

24. The sensor device of claim 22 wherein the knurling is longitudinal knurling.

25. An electromechanical power steering system for a motor vehicle, the electromechanical power steering system comprising the sensor device of claim 17.

26. The electromechanical power steering system of claim 25 wherein the rotating shaft is a steering shaft of the electromechanical power steering system.

27. The electromechanical power steering system of claim 25 wherein the rotating shaft is a rotor shaft of an electric motor.

28. A method for assembling a sensor device for detecting an angular position of a rotating shaft that is rotatably supported in a housing, with a transducer magnet that is configured to be attached to a supporting part that is connectable to the rotating shaft, the method comprising:
partially inserting the supporting part into the transducer magnet with a defined pressure;
introducing a high-frequency mechanical vibration in an ultrasonic range into the supporting part;
pressing the supporting part into the transducer magnet with a defined pressure; and
introducing the supporting part into the rotating shaft.

29. The method of claim 28 wherein the ultrasonic range is 20 to 40 kHz.

30. The method of claim 28 wherein the ultrasonic range is about 35 kHz.

31. The method of claim 28 wherein the transducer magnet comprises plastic, wherein introducing the high-frequency mechanical vibration in the ultrasonic range into the supporting part at least partially heats and plasticizes the transducer magnet.

32. The method of claim 31 wherein an outside of the supporting part has knurling and wherein the transducer magnet that has been at least partially plasticized flows around undercuts of the knurling such that after cooling a shape-locking, bonded joint exists between the transducer magnet and the supporting part.

33. The method of claim 28 wherein the supporting part is a supporting rod.

34. The method of claim 33 wherein the transducer magnet is ring-shaped and encloses the supporting rod.
